(19) United States
(12) Patent Application Publication
(10) Pub. No.: US 2003/0000062 A1
(43) Pub. Date: Jan. 2, 2003

(54) Rotary tool for surface machining and method for its manufacture

(76) Inventors: Edgar Dufner, Seitingen-Oberflacht (DE); Helmut Dufner, Seitingen-Oberflacht (DE)

Correspondence Address: QUARLES & BRADY LLP, 411 E. WISCONSIN AVENUE, SUITE 2040, MILWAUKEE, WI, 53202-4497, US

(21) Appl. No.: 10/087,575

(22) Filed: Mar. 1, 2002

(30) Foreign Application Priority Data
Mar. 2, 2001 (DE) 10110739.0

(51) Int. Cl. B23P 11/00; B21D 39/03

(52) U.S. Cl. 29/428

(57) ABSTRACT

In a method for the manufacture of a rotary tool for surface machining, firstly a first retaining element of a retaining device is fixed to a clamping pin. The tool body is mounted on the clamping pin until an axial end of the tool body strikes against the first retaining element. A second retaining element of the retaining device is mounted on the clamping pin up to a freely predeterminable retaining position, where the second retaining element engages with the other axial end of the tool body. A compressible tool body, e.g. of nonwoven grinding disks can be axially compressed. At the end of the manufacturing process the second retaining element is fixed on the clamping pin in its retaining position, which in the preferred embodiments takes place in that the retaining element is dimensioned for a press fit on the clamping pin, so that it is automatically secured on the latter.

### BACKGROUND OF THE INVENTION

1. Field of the Invention

The invention relates to a rotary tool for surface machining and to a method for its manufacture. The rotary tool has a clamping pin for clamping in a clamping device which can be driven in rotary manner and at least one tool body arranged around and fixed to the clamping pin.

2. Description of the Related Art

Rotary tools of this type, in which the surface machining is preponderantly performed with the radial outsides of the tool body, are used in the most varied fields ranging from deburring to polishing. For example they can be used for grinding off or abrading car varnishes or the mirror-finishing of surfaces and the like. The rotary tool can e.g. be constructed in such a way that it is clamped in a chuck of a drilling machine and can be driven in rotary manner by the latter.

In order to achieve optimum grinding or polishing results with the rotary tool, it is necessary to secure the tool body both against twisting and against axial displacement on the clamping pin. A possibility known from the prior art is to provide the clamping pin with a shoulder. The shoulder is used for the engagement of a washer or the like, through which the tool body subsequently engaged on the clamping pin is fixed against axial displacement in the mounting direction. At the upper end of the clamping pin is located a relatively short threaded portion onto which is screwed a further retaining element in the form of a nut, so that the tool body is secured between the two retaining elements. In order to prevent the unintentional loosening again of said nut, the upper end of the clamping pin projecting over the nut is flat-riveted. In this rotary tool embodiment the spacing between the shoulder and the threaded portion is predetermined and matched to the height of the tool body to be fitted. If a tool body with another height is required, it is necessary to use a clamping pin individually adapted thereto.

Another possibility for fixing the tool body to the clamping pin and simultaneously secure the same against twisting and axial displacement, comprises using an adhesive, e.g. cast resin. For this purpose the tool body is centrally provided with a through hole or bore, whose diameter is generally significantly larger than the external diameter of the clamping pin. For fixing the tool body the gap between the clamping pin and the wall of the tool body hole is filled with adhesive. Disadvantageously said method is very time-consuming, because the adhesive requires a certain drying time. In addition, the adhesive is relatively expensive and not environmentally advantageous. It also constantly arises that when filling takes place adhesive runs alongside the area in question and makes the work place dirty, so that subsequent cleaning thereof is necessary.

The object of the invention is to provide a manufacturing method for rotary tools, which allows a rapid, flexible and cost-effective manufacture of said rotary tools, whilst providing a rotary tool for surface machining, which can be easily and cost-effectively manufactured. The disadvantages of the aforementioned prior art are to be avoided.

### SUMMARY OF THE INVENTION

This problem is solved by a method for manufacturing a rotary tool for surface machining, the rotary tool having a clamping pin for clamping in a clamping device drivable in rotary manner and at least one tool body arranged around and fixed to the clamping pin, the method comprising the following steps:

fixing a first retaining element of a retaining device to the clamping pin;

pushing the tool body on the clamping pin until an axial end of that tool body strikes against the first retaining element;

pushing a second retaining element of the retaining device on the clamping pin up to a freely predeterminable retaining position, where the second retaining element is in engagement with the other axial end of the tool body;

fixing the second retaining element to the clamping pin in the retaining position. It is also solved by a rotary tool for surface machining comprising:

a clamping pin for clamping in a clamping device drivable in rotary manner;

a tool body surrounding the clamping pin;

a retaining device for fixing the tool body on the clamping pin;

the retaining device comprising a first retaining element fixable to the clamping pin for engagement on an axial end of a tool body and a second retaining element for engaging an opposite axial end of the tool body;

wherein the second retaining element is freely displaceable along the clamping pin by pushing the second retaining element on the clamping pin and wherein the second retaining element is fixable on the clamping pin in a predeterminable retaining position.

In the inventive method for the manufacture of the rotary tool, initially a first retaining element of a retaining device is fixed to the clamping pin. Then the tool body is pushed on the clamping pin until an axial end thereof strikes against the first retaining element. A second retaining element of the retaining device is then pushed on the clamping pin up to a freely predeterminable retaining position, where the second retaining element engages with the other axial end of the tool body. The second retaining element is fixed to the clamping pin in the retaining position.

Thus, through the axial displacement of the second retaining element, the rotary tool can be adjusted to very different, continuously adjustable tool body heights. This e.g. leads to individual stackability if the tool body is built up from several parts, e.g. disks or washers. In the case of the rotary tools according to the invention, for tool bodies of the most varied natures and heights, it is always possible to use the same clamping pins and the same retaining elements. It is merely necessary to modify or appropriately set the relative positioning of the retaining elements with respect to one another. Compared with a rotary tool having a clamping pin with a shoulder and a threaded portion, it is consequently unnecessary to stock clamping pins constructed in different ways. The pushing-on action does not require rotation of the retaining element as is the case for retaining elements which must be screwed on a threaded portion of a pin. The effect of the pushing-on action may also be achieved by pulling the second retaining element in the direction of the tool body or by a combination of pushing and pulling. Due to the fact that the tool body is directly clamped on the clamping pin between the retaining elements and is secured against twisting and axial displacement, it is possible to economize the very time-consuming, expensive working step encountered in other conventional rotary tools, namely the bonding of the tool body to the clamping pin.

Surface machining methods in the sense of the present invention are all suitable methods performable with a rotary tool, such as e.g. polishing, grinding, deburring, lustre finishing, etc. The rotary tool can e.g. be constructed as a grinding mop, burnishing mop, etc. In the case of the rotary tools considered here, for surface machining purposes use is preponderantly made of the radial outsides of the tool body and optionally also a front face facing the clamping side. The clamping device drivable in rotary manner can e.g. be a chuck of a drilling machine, a grinding machine or a flexible shaft. The clamping pin of the rotary tool has a clamping portion used for clamping in the clamping device. The tool body is preferably arranged in rotationally symmetrical manner about a tool support portion of the clamping pin in such a way that during the operation of the rotary tool no unbalances occur, which could possibly give rise to undesired grinding or polishing grooves on the machined workpiece. All materials suitable for the aforementioned surface machining methods can be used for the tool body. They can consist of flexible materials, such as e.g. felts, nonwovens, synthetic fibres, foams, etc., which can be fixed to the clamping pin in one piece or in several layers, e.g. stacked in disk-like manner. Tool bodies made from flexible materials are generally called mops. However, it is also conceivable to use inflexible or substantially hard materials, such as e.g. wood and the like for corresponding surface machining tasks.

The second retaining element can be fixed to the clamping pin in different ways. It is e.g. possible to bond or weld the second retaining element to the clamping pin. Fixing by means of fixing aids such as screws, staples, rivets, etc. is also conceivable. However, preference is given to the fixing of the second retaining element to the clamping pin without separate fixing or fastening aids. This preferably takes place exclusively by frictional connection or force closure between the retaining element and the clamping pin. A suitable method for this is e.g. a pressing process, in which the retaining element, initially loosely fitted onto the clamping pin, is pressed onto the latter using a press. The fixing of the second retaining element in the retaining position can also take place by means of a shrinkage process.

In particularly preferred manner the second retaining element is mounted or engaged in the retaining position under the action of a thrust and accompanied by the overcoming of friction between the second retaining element and the clamping pin. Thus, the second retaining element is dimensioned in such a way that in the absence of external forces it is automatically force or frictionally fixed to the clamping pin. After removing the thrust the second retaining element can be automatically secured in force-closed manner on the clamping pin in the retaining position. Preferably the retaining elements have in each case a recess, particularly a central opening making it possible to mount the retaining elements on the clamping pin. Preferably the diameter of the central opening, at least of the second retaining element, is somewhat smaller than the external dimensions, particularly the diameter of the clamping pin. Thus, the second retaining element is preferably fixed by press fit to the clamping pin. Due to the fact that the tool body is generally clamped between the two retaining elements accompanied by compression, a force acts on both retaining elements and attempts to press them out of their retaining positions. Thus, on pressing on the retaining elements, it must be ensured that the frictional force acting between the clamping pin and both retaining elements exceeds said “reaction force” of the tool body.

In order to ensure an optimum mounting or engagement of the second retaining element, substantially over its entire length the clamping pin preferably has a uniform and preferably circular cross-section. Such cylindrical pins without shoulders, projections or the like are available in large numbers and virtually random lengths in a particularly cost-effective manner. It is also possible to have non-circular cross-sections, e.g. hexagonal cross-sections, which facilitate the securing of the retaining elements on the clamping pin in such a way that twisting does not occur.

As a result of the possibility of fixing the second retaining element at a random axial position of the clamping pin, the height and strength of a flexible or compressible tool body can be adjusted at random. Preferably the second retaining element is engaged on the clamping pin in the direction of the first retaining element to such an extent that the tool body is axially compressed at least in an inner area close to the clamping pin. This is particularly advantageous in the case of multipart tool bodies comprising several stacked disks, because this prevents a gap remaining between the individual disks, so that the tool body possibly starts to “flutter” in operation. The tool body can optionally be compressed to less than 80%, particularly to less than 50% of the axial length of the force-free tool body.

According to a further development of the invention, the tool body is fixed to the clamping pin so as not to twist exclusively through the retaining elements. For twist-prevention purposes, it is e.g. possible to construct axial projections on the retaining elements, which penetrate the tool body material. The axial projections can e.g. be in the form of claws, prongs or points. In the case of inflexible and optionally hard tool body materials, it is advantageous if the axial projections have a self-cutting form, e.g. in the form of a tip or point, so that on engaging the retaining elements the projection penetrates the tool body material. The axial projections are preferably constructed in one piece with the retaining elements and are uniformly and in particular rotationally symmetrically placed on the retaining elements. The axial projections can e.g. be produced by bending round portions of the retaining elements constructed in projection-like manner.

The invention also relates to a rotary tool for surface machining comprising:

a clamping pin for clamping in a clamping device drivable in rotary manner;

a tool body surrounding the clamping pin;

a retaining device for fixing the tool body on the clamping pin;

the retaining device comprising a first retaining element fixable to the clamping pin for engagement on an axial end of a tool body and a second retaining element for engaging an opposite axial end of the tool body;

wherein the second retaining element is freely displaceable along the clamping pin by pushing the second retaining element on the clamping pin and wherein the second retaining element is fixable on the clamping pin in a predeterminable retaining position.

The rotary tool is characterized in that the retaining device has a first retaining element fixable to the clamping pin for engagement on an axial end of the tool body and a second retaining element displaceable along the clamping pin in a free or continuous manner and fixable in a retaining position, for engagement on the other axial end of the tool body.

For further details of the rotary tool reference is made to the preceding and the succeeding description.

The above and further features can be gathered from the claims, description and drawings and the individual features, both singly or in the form of subcombinations, can be implemented in an embodiment of the invention and in other fields and can represent advantageous, independently protectable constructions for which protection is claimed here.

The subdivision of the application into individual sections and the subtitles in no way restrict the general validity of the statements made thereunder.

### BRIEF DESCRIPTION OF THE DRAWINGS

An embodiment of the invention is described in greater detail hereinafter relative to the attached drawings, wherein show:

FIG. 1 A longitudinal section through an embodiment of a rotary tool according to the invention.

FIG. 2 A plan view of a retaining element of the rotary tool.

FIG. 3 A first step in the manufacture of another rotary tool.

FIG. 4 A second step in the manufacture of the rotary tool.

FIG. 5 A third step in the manufacture of the rotary tool.

### DETAILED DESCRIPTION OF THE PREFERRED EMBODIMENT

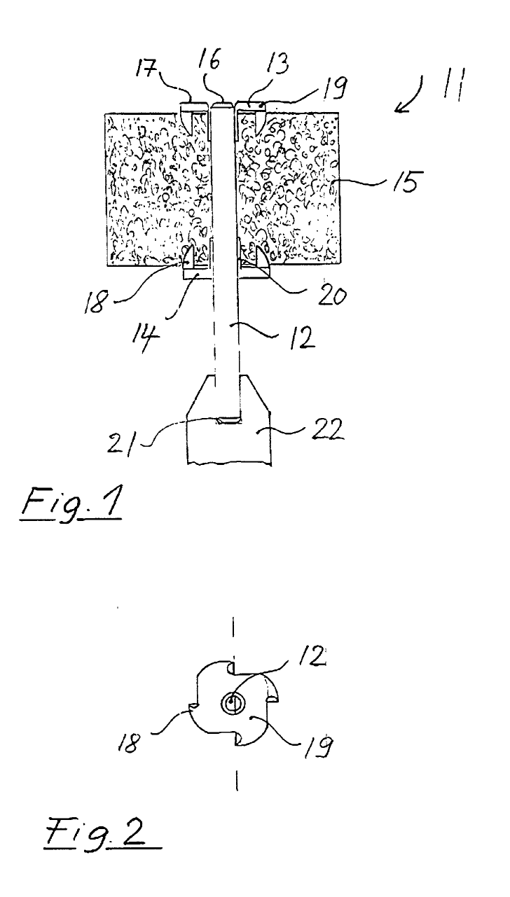

FIG. 1 shows an embodiment of the rotary tool 11 according to the invention. The rotary tool 11 comprises a clamping pin 12, a retaining device with two retaining elements 13, 14 fixable to the clamping pin and a tool body 15 clamped between the retaining elements 13, 14.

The circular cylindrical clamping pin 12 is manufactured from a blank by cutting to the desired length. A particularly suitable material is steel, especially stainless steel. The clamping pin 12 has a circular diameter, typically approximately 0.5 to 3.0 cm. The length of the clamping pin 12 according to the embodiment is approximately 9 to 10 cm. Smaller and larger diameters and lengths are possible as a function of the given application. Over its entire length the clamping pin 12 has a uniform cross-section.

As shown in FIG. 1 two retaining elements 13, 14 are fixed to the clamping pin 12. The first retaining element 13 is located directly at one end 16 of the clamping pin 12. The top 17 of the first retaining element 13 and the end of the clamping pin 12 form a common, flush termination. The second retaining element 14 can be fixed at a random point along the clamping pin 12. In the embodiment described the second retaining element is located approximately in the centre of the clamping pin 12.

In the manner shown in FIG. 2, the in each case one-piece pair of retaining elements are constructed in the manner of a paddle wheel. On the circumference and at regular intervals, they have four axial projections 18 constructed in the manner of paddles. As shown in FIG. 1, the axial projections 18 are bent upwards or downwards at an angle of approximately 90ø from a disk-like base portion 19 of the retaining element 13, 14. In the longitudinal direction the axial projections 18 are in the form of pointed prongs, so that they can relatively easily penetrate the tool body 15. The retaining elements 13, 14 also have a sleeve-like central portion 20, which is in direct contact with the clamping pin 12 and forms a central, cylindrical passage opening for the clamping pin. The retaining elements 13, 14 can be manufactured simply by punching from a piece of sheet metal. The axial projections 18 can then be bent downwards by approx. 90° with the aid of a suitable tool.

The tool body 15 can have all forms which are suitable for the most varied surface machining methods such as grinding, polishing, deburring, etc. Suitable materials are flexible, inflexible, hard or soft materials, e.g. nonwovens, felts, synthetic fibres, foams, wood or the like. The tool body 15 is arranged in rotationally symmetrical manner around the clamping pin 12 and can comprise one piece, as is e.g. shown in FIG. 1, or several layers, e.g. several workpiece material disks, as shown in FIGS. 4 or 5. The tool body 15 shown in FIG. 1 is e.g. in one piece and is made from foam.

In order to drive the rotary tool 11, a clamping end 21 of the clamping pin 12, which faces the end 16 provided with the first retaining element 13, is inserted in a clamping device 22. As shown in the embodiment of FIG. 1, the clamping device can be a drilling machine chuck.

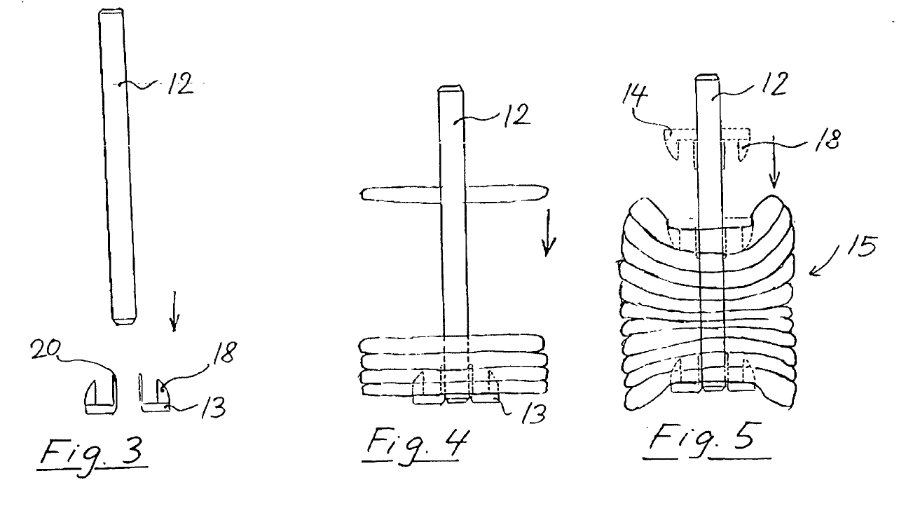

FIGS. 3 to 5 illustrate the manufacturing process for a rotary tool. Firstly and as shown in FIG. 3, a cut to length clamping pin is engaged on the first retaining element 13. In the method according to the invention, it is particularly advantageous that the length and construction of the clamping pin 12 can be completely independent of the tool body height. Thus, for the manufacture of the most varied rotary tools, it is possible in each case to use the same “standard” clamping pins 12. In order to engage the clamping pin 12 on the first retaining element 13, the clamping pin is held at the opposite end in a not shown press and under a high thrust force is pressed into the first retaining element 13. The diameter of the clamping pin 12 exceeds the internal diameter of the sleeve-like central portion of the first retaining element 13. On removing the thrust force through the press, between the first retaining element and the clamping pin a press fit is formed. Optionally pressing can take place with a radial pressing force.

Next and as shown in FIG. 4, the tool body 15 is engaged or mounted. In the embodiment shown the tool body comprises several nonwoven grinding wheels or disks, which are stacked in superimposed manner. Generally the individual tool body disks have a central bore in order to facilitate engagement on the clamping pin. In the case of soft materials, e.g. foam, engagement can take place by pushing the clamping pin through the tool body material. The material disks are fixed on the first retaining element 13 against axial displacement in the engagement direction. The axial projections 18 of the first retaining element 13 press at least into the nearest disks.

Then and as shown in FIG. 5, the second retaining element 14 is pushed on. As for the clamping pin in the first stage, the retaining element is clamped in an e.g. hydraulically operated press and is moved by thrust action into its final retaining position.

The internal diameter of the sleeve-like central portion 20 of the second retaining element 14 is smaller than the diameter of the clamping pin 12. As a result a displacement along the clamping pin can only take place if strong frictional forces are overcome. On removing the thrust force a press fit is automatically formed between the second retaining element and the clamping pin 12. Thus, there is no need for separate fixing means or measures such as screw, welding, bonding, squeezing, etc., in order to ensure a firm seating of the second retaining element on the clamping pin.

It is particularly advantageous in this method that the second retaining element 14 can be fixed at a random position along the clamping pin. As a result it is possible to individually continuously adjust the tool body height and strength. In the manner shown in FIG. 5, the tool body 15 is clamped between both retaining elements 13, 14. The material layers in an inner area close to the clamping pin are highly compressed. In this area the centre height determined by the axial spacing of the retaining elements is approximately only 70 to 80% or less than the stack height of an uncompressed disk stack. As a result the outer contour of the tool body becomes barrel-shaped.

As shown in FIG. 5, at least in an inner area close to the clamping pin, the tool body is greatly axially compressed. The axial projections 18 of the second retaining element 14 also penetrate the tool body and together with the axial projections 18 of the first retaining element 13 ensure that the tool body does not twist with respect to the clamping pin 12 and the two retaining elements 13, 14. This allows an optimum, uniform machining by the rotary tool.

1. Method for manufacturing a rotary tool for surface machining, the rotary tool having a clamping pin for clamping in a clamping device drivable in rotary manner and at least one tool body arranged around and fixed to the clamping pin, the method comprising the following steps:
fixing a first retaining element of a retaining device to the clamping pin;
pushing the tool body on the clamping pin until an axial end of that tool body strikes against the first retaining element;
pushing a second retaining element of the retaining device on the clamping pin up to a freely predeterminable retaining position, where the second retaining element is in engagement with the other axial end of the tool body;
fixing the second retaining element to the clamping pin in the retaining position.

2. Method according to claim 1, wherein the second retaining element is fixed to the clamping pin without separate fixing means substantially by frictional connection between the retaining element at the clamping pin.

3. Method according to claim 1, wherein pushing-on of the second retaining element into the retaining position is performed under the action of a thrust force and whilst overcoming the friction between the second retaining element and the clamping pin and wherein after removing the thrust force the second retaining element is automatically secured by frictional connection on the clamping pin in the retaining position.

4. Method according to claim 1, wherein the second retaining element is pushed on the clamping pin in the direction of the first retaining element to such an extent that the tool body is axially compressed at least in an inner area close to the clamping pin.

5. Method according to claim 4, wherein on compressing the tool body the tool body is compressed to an extent that a compressed length in the compressed inner area close to the clamping pin is at least one of less than 80% and less than 50% of the axial length of a force-free tool body.

6. Method according to claim 1, wherein the tool body is fixed to the clamping pin to prevent relative rotation of the clamping pin and the tool body so as not to twist exclusively by the retaining elements.

7. Rotary tool for surface machining comprising:
a clamping pin for clamping in a clamping device drivable in rotary manner;
a tool body surrounding the clamping pin;
a retaining device for fixing the tool body on the clamping pin;
the retaining device comprising a first retaining element fixable to the clamping pin for engagement on an axial end of a tool body and a second retaining element for engaging an opposite axial end of the tool body;
wherein the second retaining element is freely displaceable along the clamping pin by pushing the second retaining element on the clamping pin and wherein the second retaining element is fixable on the clamping pin in a predeterminable retaining position.

8. Rotary tool according to claim 7, wherein at least one of the retaining elements has a through opening adapted for fitting the clamping pin through the through opening, wherein the through opening is dimensioned for building up a press fit between the retaining element and the clamping pin in such a manner that the retaining element is displaceable along the clamping pin by means of an axially acting thrust and whilst overcoming friction between the retaining element and the clamping pin and wherein the retaining element is fixed automatically to the clamping pin by frictional connection on removing the thrust.

9. Rotary tool according to claim 8, wherein the second retaining element has a through opening adapted for fitting the clamping pin through the through opening, wherein the through opening is dimensioned for building up a press fit between the retaining element and the clamping pin in such a manner that the retaining element is displaceable along the clamping pin by means of an axially acting thrust and whilst overcoming friction between the retaining element and the clamping pin and wherein the retaining element is fixed automatically to the clamping pin by frictional connection on removing the thrust.

10. Rotary tool according to claim 7, wherein the tool body is made from a compressible material at least in an inner area close to the clamping pin and wherein the tool body is compressed at least in the inner area close to the clamping pin by means of the retaining elements in such a way that the spacing between the retaining elements is smaller than an axial height of the force-free tool body.

11. Rotary tool according to claim 10, wherein the axial spacing between the retaining element is at least one of less than 80% and less than 50% of the axial height of the force-free tool body.

12. Rotary tool according to claim 7, wherein the tool body has a stack of several, axially superimposed disks made of a tool material.

13. Rotary tool according to claim 12, wherein the disks of tool material are at least one of substantially identically dimensioned and made from the same tool material.

14. Rotary tool according to claim 1, wherein the clamping pin has a uniform cross-section substantially over the entire length of the clamping pin.

15. Rotary tool according to claim 14, wherein the cross-section of the clamping pin is circular.

16. Rotary tool according to claim 1, wherein at least one of the first retaining element and the second retaining element has devices for preventing twisting of the tool body relative to the clamping pin.

17. Rotary tool according to claim 16, wherein the device for preventing twisting of the tool body comprise axial projections formed on at least one of the first retaining element and the second element, wherein the axial projections are constructed for penetrating the tool body material compressing the tool body.

18. Rotary tool according to claim 7, wherein the rotary tool is one of a grinding mob or a polishing mob.
